(19) United States
(12) Patent Application Publication
(10) Pub. No.: US 2014/0254691 A1
(43) Pub. Date: Sep. 11, 2014

(54) BITSTREAM PROCESSING USING MARKER CODES WITH OFFSET VALUES

(71) Applicant: BROADCOM CORPORATION, Irvine, CA (US)

(72) Inventors: Wade K. WAN, Orange, CA (US); Vladimir SILYAEV, Laguna Niguel, CA (US)

(73) Assignee: BROADCOM CORPORATION, Irvine, CA (US)

(21) Appl. No.: 14/286,789

(22) Filed: May 23, 2014

Related U.S. Application Data
(63) Continuation of application No. 11/731,227, filed on Mar. 30, 2007.

(51) Int. Cl. H04N 19/46

(52) U.S. Cl. CPC H04N 19/00545
USPC 375/240.26

(57) ABSTRACT

A sequence of data within a bitstream may be determined. An offset value corresponding to a location of a validity code within the bitstream may be determined, relative to the sequence of data. A marker code and the offset value may be inserted into the bitstream in association with the sequence of data. Also, a received bitstream may be scanned to determine a potential marker code, a potential offset value may be determined, based on the potential marker code. A validity code within the bitstream may be determined, based on the potential offset value, and a validity of the potential marker code may be determined, based on the validity code.

### TECHNICAL FIELD

This description relates to processing audio-visual data streams.

### BACKGROUND

Digital content, including, for example, audio and/or video streams, may be transmitted for reception, use, and enjoyment by a receiving user. For example, television shows, movies, or other recordings may be transmitted across a computer network, or broadcast over the air, or transmitted by way of cable and/or satellite systems. In so doing, the digital content may be encoded, compressed, and/or modified, in order, for example, to conserve bandwidths in the various transmission schemes, and/or to speed the transmission of the audio and/or video streams.

After being encoded and transmitted, the digital content may be received by a user and decoded for use and enjoyment thereof, as just referenced. For example, a decoder may be associated with a television or associated set-top box of some sort, so that the encoded, compressed audio-video streams may be decoded and passed to the television (or other display) for presentation to the user.

Such data streams often include discrete sequences of data, the location of which within the data stream may be useful to know during decoding or other processing of the data stream. For example, a discrete sequence of data may include some or all of the data for a particular video frame, audio frame, or image. It may be useful to designate such sequences with easily-recognizable data, such as a start code, which indicates the beginning of (and other information regarding) the sequence of data. Thus, insertion of a start code into such a data stream at the beginning of a sequence of data may facilitate decoding, synchronizing, or other processing of the sequence and/or the data stream as a whole.

In practice, however, it may occur that the data stream already includes, by chance, a byte sequence that exactly matches the inserted start code. Consequently, when processing a received data stream, it may occur that a decoder or other processing equipment mistakes such a coincidental or false byte sequence for an actual start code. Such a mistake may lead to failures or errors in decoding or otherwise processing the received data stream. Although techniques exist to mitigate or reduce such mis-identification of start codes, such techniques may require undesirably large amounts of processing of the data stream, or otherwise may not be practical or useful in all cases.

### SUMMARY

According to one general aspect, a system includes a sequence identifier configured to determine a sequence of data within a bitstream, an offset calculator configured to determine an offset value corresponding to a location of a validity code within the bitstream, relative to the sequence of data, and code insertion logic configured to insert a marker code and the offset value into the bitstream in association with the sequence of data.

According to another general aspect, a system includes a scanner configured to scan a received bitstream to determine a potential marker code, an offset extractor configured to determine a potential offset value based on the potential marker code, and a code verifier configured to determine a validity code within the bitstream, based on the potential offset value, and to determine a validity of the potential marker code, based on the validity code.

According to another general aspect, a method includes determining a sequence of data within a bitstream, determining an offset value corresponding to a location of a validity code within the bitstream, relative to the sequence of data, and inserting a marker code and the offset value into the bitstream in association with the sequence of data.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for processing bitstreams using marker codes with offset values.

FIG. 2 is a block diagram of an example bitstream processed by the system of FIG. 1.

FIGS. 3A and 3B are example byte sequences illustrating insertion and processing of marker codes and offset values within a bitstream.

FIG. 4 is a flowchart illustrating example operations of the system of FIG. 1.

FIG. 5 is a flowchart illustrating example insertion operations of a marker code insertion system of FIG. 1.

FIG. 6 is a flowchart illustrating example detection operations of a marker code detection system of FIG. 1.

### DETAILED DESCRIPTION

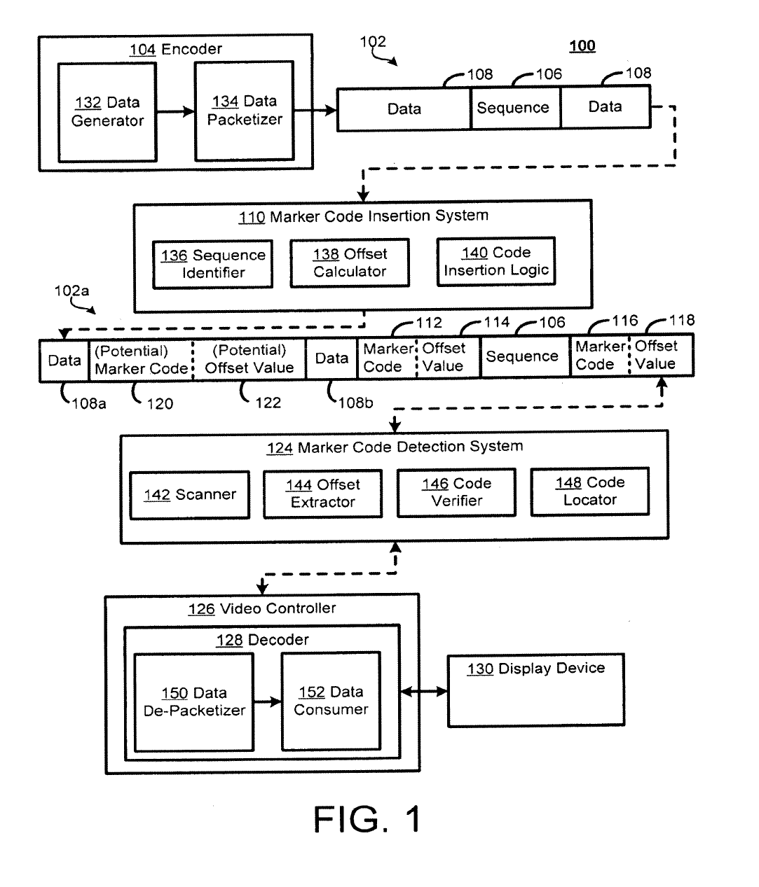

FIG. 1 is a block diagram of a system 100 for processing bitstreams using marker codes with offset values. In the example of FIG. 1, the system 100 allows insertion of marker codes having offset values within processed bitstreams, while requiring a minimum of processing to do so. The offset values allow the system 100 to identify and validate the marker codes as such. Further, once one or more such marker codes are identified and validated in a received bitstream, the system 100 reduces or eliminates a need to scan through an entirety of the bitstream to determine subsequent marker codes, since, for example, the offset values may identify such subsequent maker codes without requiring analysis or inspection of intermediate data between the marker codes.

In FIG. 1, a bitstream 102 refers to transmitted and/or stored data that may include, for example, information related to television shows, movies, songs, radio programs, still pictures, text, websites, animation, or any other information that may be transmitted and/or stored for the use and enjoyment of a receiving user, including, for example, pay-per-view and/or video-on-demand movies or other programming. The bitstream 102 may represent a coded or encoded bitstream, where, for example, analog video may have been converted by an encoder 104 into digital video, according to some pre-defined or known conversion process (or where digital content of one format has been converted into digital content of another format).

As such, the bitstream 102 may be compressed, again, for example, by operation of the encoder 104. For example, the bitstream 102 may have been analyzed to remove or reduce redundancies or other data that is considered more or less extraneous for a given purpose. Such compression allows, for example, conservation of bandwidth associated with transmission of the bitstream 102, as well as efficient use of any memory associated with storage of the bitstream 102. By way of example and not limitation, then, coding/decoding standards (also referred to as codecs) and/or related container formats that may be used in the various processes described herein may include, to name a few non-limiting examples, various versions of the Moving Pictures Experts Group (MPEG) standard (e.g., MPEG-1, MPEG-2, and/or MPEG-4), Quicktime, audio-video interleave (.avi), Ogg (.ogg), True Audio (.tta), VC-1, DivX 3.11, and/or the H.264 compression algorithm (also known as H.264, and/or MPEG-4 Part 10/Advanced Video Coding (AVC), and/or “the JVT codec,” where the latter nomenclature refers to the Joint Video Team involved with creation of this codec).

In FIG. 1, the bitstream 102 is shown as including a data sequence 106, as well as other data 108. That is, the sequence 106 generically represents a particular, discrete sequence of data, such as a video frame, image, audio frame, a portion of an image, an image slice, a grouping of images, a grouping of audio files, or virtually any other discrete occurrence of audio-visual data. A user or downstream processor may wish to know a location of such a sequence when decoding, synchronizing, or otherwise processing the bitstream 102.

Meanwhile, the data 108 may generally or generically represent included data that is differentiated from the sequence 106 for purposes of this description. The data 108 may include virtually any data that may be included in the bitstream 102, including security (e.g., authorization) information, header information, and/or other such sequences as the sequence 106). In particular, as referenced above and illustrated below, the data 108 may include one or more byte sequences that coincidentally match marker code that is to be inserted into the bitstream 102 to mark a location of the sequence 106. As referenced, the coincidental inclusion of such byte sequences within the data 108 may lead to errors in later processing of the bitstream 102, such as if the coincidental byte sequences were mistakenly recognized as actual marker codes (e.g., start codes).

A marker code insertion system 110 may thus receive the bitstream 102 and proceed to process the bitstream 102 to produce a modified bitstream 102a that includes a marker code 112 and an offset value 114 that are associated with the sequence 106. As described in detail herein, the marker code 112 may thereafter be recognized, for example, as indicating a beginning of the sequence 106. More generally, the term marker code may refer to any code within the modified bitstream 102a that may be useful in decoding or otherwise processing the modified bitstream 102a, or similar bitstreams.

For example, the marker code 112 may be used to establish synchronization between the modified bitstream 102a and another bitstream (not shown in FIG. 1), or to perform re-synchronization in case of bit errors, or may be used to search the modified bitstream 102a to determine a beginning of one or more layers of video. The marker code 112 also may provide an entry point for random access into the modified bitstream 102a when the reception of the modified bitstream 102a begins somewhere other than a beginning of the modified bitstream 102a. In some examples, the marker code 112 may include a start code that is used for some or all of the above purposes. However, the marker code 112 also may occur at an end of the sequence 106, e.g., to mark an ending of a video frame, image, or audio frame. Many other examples of the marker code 112 may be implemented using the system of FIG. 1, as will be appreciated.

In FIG. 1, the offset value 114 may include a distance to a subsequent marker code 116, which may itself be associated with an offset value 118 (and which may mark a beginning of a new sequence of data, not shown in FIG. 1, that is analogous to the sequence 106). As described in detail herein, the offset value 114 thus provides at least the following features or advantages during processing of the modified bitstream 102a. For example, by using the distance indicated in the offset value 114, a marker code detection system 124 that receives the modified bitstream 102a may identify the marker code 112 as a possible or potential marker code, and may validate the marker code 112 as an actual or valid marker code by using the offset value 114 to locate the subsequent marker code 116 within the bitstream 102a.

By determining that the subsequent marker code 116 is, in fact, a valid marker code, the marker code detection system 124 may validate the original marker code 112 itself as a valid marker code, (i.e., may reduce or eliminate the possibility that the marker code 112 is simply a coincidental or chance occurrence of a designated marker code pattern within the data 108). Further, with the knowledge provided by the offset value 114 of the location of the subsequent marker code 116, the marker code detection system 124 may reduce or avoid, if desired, scanning or processing of some or all of the intervening sequence 106 (or any other intervening data, not shown in FIG. 1). In other words, the marker code detection system 124 may not need to scan all of the modified bitstream 102a, but, rather, may simply proceed to a desired location within the modified bitstream 102a by skipping from one marker code to the next (once the first marker code 112 is validated as such).

In practice, then, the marker code detection system 124 may receive the modified bitstream 102a and may begin processing by scanning the modified bitstream 102a. In the example of FIG. 1, the data 108a is scanned but no marker code (or potential, i.e., coincidenta(, marker code) may be included or detected. Then, a potential marker code 120 may be recognized, which may represent, in this example, a false marker code that is part of the data 108 that happens to include the selected byte sequence selected for the marker code(s) 112, 116.

Consequently, the marker code detection system 124 may extract a potential offset value 122, i.e., a byte sequence that would represent an offset value to a next-subsequent marker code if the potential marker code 120 were, in fact, a valid marker code. When the potential marker code 120 is a false marker code, the potential offset value 122 (i.e., the bits of data that reside at a location within the potential marker code 120 designated for inclusion of an offset value) is very unlikely to point to a next subsequent marker code (e.g., the marker code 112), and, rather, is very likely to point to some other location within the modified bitstream 102a (e.g., may provide a distance to a middle of the sequence 106). In this case, the marker code detection system 124 may determine that the potential marker code 120 does not have an offset value pointing to a next-subsequent marker code, and is therefore not itself a valid marker codc. The marker code detection system 124 may thus proceed to scan the modified bitstream 102a until the marker code 112 (i.e., the next potential marker code) is recognized (and, as described above, validated as such by using the offset value 114 to detect and recognize the next-subsequent marker code 116).

Once the marker codes 112, 116 are recognized by a video controller 126, e.g., by an included decoder 128, the bitstream 102 may be presented as audio and/or visual output at a display device 130 (e.g., a television, computer monitor, portable display, or virtually any other type of display). The video controller 126 may represent, for example, a digital video recorder (DVR) or other set-top box that may be used to receive and present audio-visual data, while the decoder 128 may perform any necessary or desired decoding or decoding-related processing associated with providing the information within the bitstream 102 to the display device 130. For example, the decoder 128 may perform decompression of the encoded bitstream 102, digital-to-analog conversion of the decompressed content, and/or other modifications designed to supplement or enhance a display or other use of the content.

Thus, it may be appreciated from the above description that the marker code insertion system 110 may be configured to convert a bitstream 102 into a modified bitstream 102a, where the modified bitstream 102a includes marker codes 112, 116 that indicate a presence of (or other information about) corresponding sequences of data, such as the sequence 106. The marker codes 112, 116 include offset values 114, 118 that provide, for examp)e, a distance to a next-subsequent marker code. With this information of a distance to the next-subsequent marker code as provided by the offset value(s) 114, 118, the marker code detection system 124 may validate a detected marker code as such (thereby avoiding erroneous detection of false marker codes such as the potential marker code 120), and thereafter may easily locate and process any subsequent marker codes (e.g., by simply observing a distance thereto as indicated by an offset value of a current marker code).

In example implementations, a number of scenarios may exist for the usage of the marker code insertion system 110 and the marker code detection system 124. For example, the marker code insertion system 110 may be included at the encoder 104. In a more particular example, the encoder 104 may be located at a transmission or re-transmission point in a supply of the bitstream 102, such as at a head-end of a cable or satellite provider (e.g., for transmission up to a satellite of a satellite provider). The encoder 104 may include, as illustrated, a data generator 132 and a data packetizer 134. The data generator 102 may represent, for example, a component that outputs a video data stream, an audio data stream, and a closed-captioning data stream, in one or more corresponding formats. Meanwhile, the data packetizer 134 may represent a component that multiplexes, synchronizes, or otherwise modifies one or more of these data streams, and that formats the resulting data in packets for transmission over one or more networks.

Data output by the data generator 132 may be continuous or discrete. For example, continuous data may be output by the data generator 132, along with additional timing and/or clock information that may be used by the data packetizer 134 to determine a beginning or end of a particular sequence (such as the sequence 106). In other examples, discrete data (such as a discrete version of the sequence 106) may be output by the data generator 132, so that the data packetizer 134 need not require additional information to determine a beginning or end of the sequence(s) (e.g., the sequence 106).

Thus, it may be appreciated that the marker code insertion system 110 may be implemented in either or both of the data generator 132 and the data packetizer 134. For example, the marker code insertion system 136 may include a sequence identifier 136 configured to determine a presence or other characteristic of the sequence 106, an offset calculator 138 configured to determine the offset value(s) 114, 118, and code insertion logic 140 that is configured to determine a need for, and location of, the marker code(s) 112, 116 (and corresponding inclusion of offset values 114, 118 as determined by the offset calculator 138).

Consequently, some of the just-mentioned components 136, 138, 140 may be implemented in (or in conjunction with) the data generator 132, while other(s) may be implemented in (or in conjunction with) the data packetizer 134, depending on the details of the implementation. Such inclusion/distribution of the components 136, 138, 140 may be based, for example, on the relevant codec(s) being used, a continuous/discrete nature of the data stream(s) output by the data generator 132, or other features of the encoder 104 or the bitstream 102, as would be apparent.

Meanwhile, the marker code detection system 124 may include a scanner 142 that is configured to scan the modified bitstream 102a as the modified bitstream 102a is received to determine a presence of a marker code or potential marker code, an offset extractor 144 that is configured to determine an offset value from a (potential) marker code, a code verifier 146 that is configured to determine a validity of a (potential) marker code by checking a next-subsequent marker code at the)ocation/distance provided by the extracted offset value, and, finally, a code locator 148 that is configured to use the current offset values and subsequent offset values to jump within the modified bitstream 102a between consecutive marker codes (without necessarily scanning intervening data for a presence of marker codes).

Corresponding to the encoder 104, the decoder 128 may similarly include a data de-packetizer 150 that reverses (e.g., de-multiplexes) an operation of the data packetizer 134, and a data consumer that provides the resulting data stream(s) in a format that is usable by the display device 130. Thus, it will again be appreciated that the marker code detection system 124 may be implemented in whole or in part within one or both of the data de-packetizer 150 and the data consumer 152.

In other example implementations, it may occur that both the marker code insertion system 110 and the marker code detection system 124 are implemented within (or in conjunction with) a single one of the encoder 104 or the decoder 128. For example, in the latter case, the decoder 128 may receive the original bitstream 102 directly from the encoder 104, or from some other source (e.g., from a memory storing the bitstream 102). The bitstream 102 may be in a particular format, such as the advanced streaming format (ASF, also known as advanced systems format). The format may not include start codes or any other mechanisms for performing the various functionality and features described above that arc normally associated with start codes (e.g., bit error resilience, synchronization, or location of desired sequences within the bitstream 102). A user of the decoder 128 may wish, or require, the use of such start codes for subsequent processing. Consequently, the marker code insertion system 110 may be used to process the initial ASF file (bitstream 102) to produce the modified bitstream 102a having the marker codes 112, 116 (which, in this example, represent start codes). Thereafter, the decoder 128 may implement the marker code detection system 124 to gain the benefits described herein of using such start codes.

Many other example implementations are possible. For example, the decoder 128 may be implemented on, and may thus represent, a single microchip. The microchip may be optimized to process bitstreams in a particular format, e.g., including start codes or other marker codes. Consequently, any bitstreams accessed or used by the decoder 128 in such examples may benefit from implementation of the marker code insertion system 110 and the marker code detection system 124.

For example, it may occur that the bitstream 102 may represent VC-1 video that is encapsulated in an ASF file, and the decoder 128 may be associated with a microchip in which encapsulation in MPEG-2 systems format is a preferred encapsulation. Such VC-1 video in an ASF file may not have inserted start codes. To the extent that start codes are included, other techniques for preventing mis-recognition of false start codes (such as the potential start code 120) may otherwise be required, where such techniques may place a large burden on an associated central processing unit (CPU). Consequently, implementation of the marker code insertion system 110 and the marker code detection system 124 in conjunction with the decoder 128 may provide use of start codes in an easy, reliable manner, that does not place an undue burden on the CPU. Similar comments may apply in other contexts, such as, for example, converting DivX (e.g., DivX 3.11) content to MPEG-2 systems format.

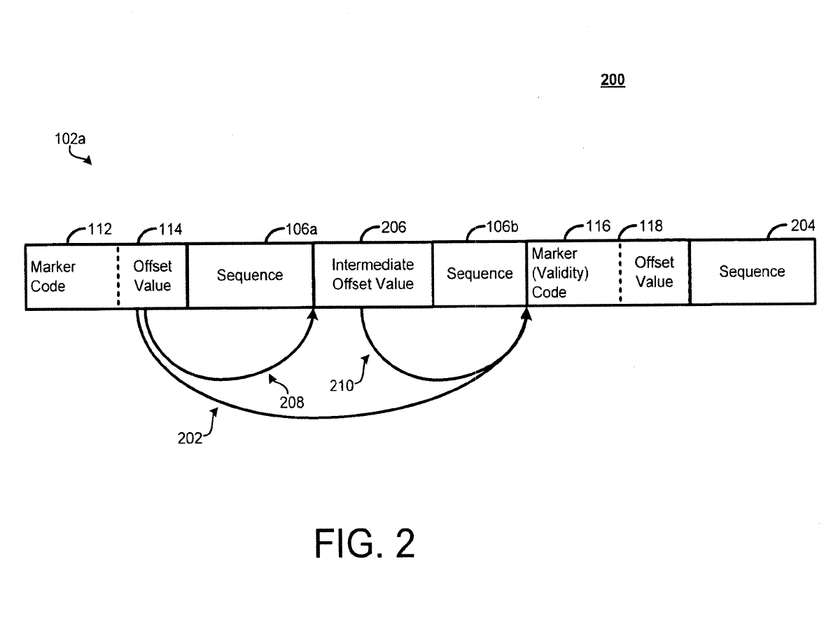

FIG. 2 is a block diagram of another example of the bitstream 102 processed by the system 100 of FIG. 1. In FIG. 1, it is discussed above that an extracted (potential) offset value from a potential marker code may be checked to determine whether the extracted (potentia)) offset value correctly identifies a next-subsequent marker code. For example, this use of the offset value 114 is indicated in FIG. 2 by indicator 202, which points from the offset value 114 to the marker code 116, thus matching the description provided above in the example of FIG. 1. In this sense, the subsequent marker code 116 may be referred to as a validity code, inasmuch as it validates the current marker code 112 as a valid marker code. In this way, as described, the marker code 112 may be validated, and subsequent sequences, such as a sequence 204 associated with the marker code 116, may easily be located and processed.

In additional or alternative implementations, however, it may occur that an intermediate offset value 206 is used to conduct the described validation scheme. For example, it may occur that a unit of data reserved or designated for the offset value 114 is equivalent to a single byte (eight bits) of data, so that the offset value 114 may include, for example, up to 255 possible values. At the same time, it may occur that a length of the sequence 106 is marginally or significantly longer than a maximum distance that may be expressed by this limited range of values (e.g., may be 500 bytes long).

In such examples, it may be possible to increase the unit of data designated for the offset value 114, however, such a solution may be impractical or impossible in a given situation. For example, if only a few such sequences exist that are longer than the maximum offset value, it may be inefficient to increase the maximum offset value (e.g., increase a number of bits allowed for expressing the offset value(s)) just to capture such sequences. More generally, it may simply be desirable to have increased flexibility in designing and using offset values, in order to achieve increased utility of the offset values in a variety of circumstances and settings.

Consequently, the intermediate offset value 206 may be used to bridge the gap between the offset value 114 and the subsequent marker (validity) code 116 (e.g., by placement between portions 106a, 106b of the sequence 106). For example, where the marker/validity code 116 is 500 bytes away from the offset value 114 and the offset value 114 and intermediate offset value 206 are limited to indicating a maximum distance of 255 bytes, then the offset value 114 may be used to identify and locate the intermediate offset value 206, as indicated by the indicator 208, while the intermediate offset value 206 may then be used to identify and locate the marker/validity code 116, as indicated by the indicator 210.

It will be appreciated that the intermediate offset value need not be associated with any marker code. For example, it may occur that the markcr code 112 is expressed using a total of 5 bytes, where the first four bytes are used to express the marker code 112 itself, and the final byte is used to express the offset value 114. In this case, the intermediate offset value need only be a single byte long. Of course, in other examples, there may be a plurality or chain of intermediate offset values, which point to one another, and, in total, serve to bridge a gap or distance between the offset value 114 and the marker/validity code 116.

In still other examples, the intermediate offset value 206 may be varied in size to meet the demands of particularly long sequences or other intervening data. Thus, the intermediate offset value 206 need not be the same size as the offset value 114, and, instead, may be greater or lesser than the offset value 114. Moreover, different sizes of the intermediate offset value 206 may be selected or determined for a single modified bitstream 102a, as needed in a particular situation or circumstance.

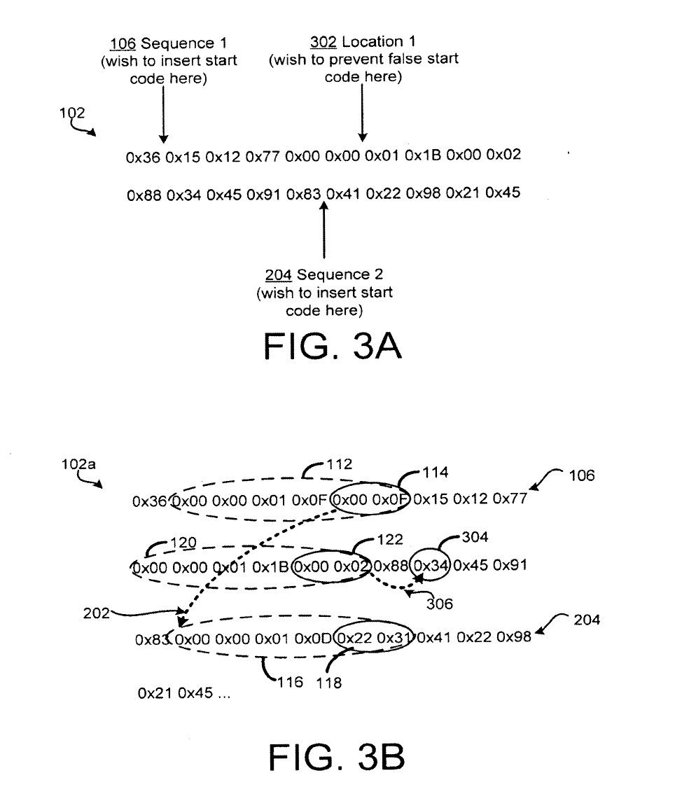

FIGS. 3A and 3B are example byte sequences illustrating insertion and processing of marker codes 112, 116 and corresponding offset values 114, 118 within the bitstream 102. In the example of FIGS. 3A and 3B, the marker codes 112, 116 are assumed to be start codes. It will be appreciated that, in principle, virtually any pattern may be inserted into the bitstream 102 and used as a start code, as long as a sender and receiver are in agreement.

A common practice in compression is to use a four byte sequence as a start code where the first three bytes are 0x00 0x00 0x01, with the fourth byte indicating the type of start code (corresponding, for example, to different types of the sequence 106). For example, the VC-1 video codec standard defines syntax in which 0x00 0x00 0x01 0x0F indicates a sequence header, 0x00 0x00 0x01 0x0D indicates the beginning of a video frame, and 0x00 0x00 0x01 0x0A indicates the end of a sequence. As referenced herein, in the context of a VC-1 video stream or other bitstream, inserting start codes allows marking of special locations, such as the sequence 106, that may then easily be found by searching through the data stream for the unique 0x00 0x00 0x01 pattern. However, as also described herein, there may be portions of the data that include the same four byte sequence as a start code, and therefore may be falsely detected as start codes.

The above scheme and syntax is expanded in the example of FIGS. 3A and 3B to include the just-described four-byte syntax for the start code(s) (as examples of the marker codes 112, 116), as well as an additional two bytes used for the corresponding offset values 114, 118. As already described, the offset values 114, 118 may then be used to transmit a number of bytes toward the next start code. For example, a six byte sequence may be used to represent a start code in which the first three bytes are 0x00 0x00 0x01, and the fourth byte indicates the type of start code (as described above), while a remaining two bytes provide the offset value indicating a number of bytes until the next start code location.

In FIG. 3A, for example, the bitstream 102 is illustrated as including the sequence 106, including the sequence starting with 0x15, as shown, as well as the sequence 204 of FIG. 2, including the sequence starting with 0x41, also as shown. As appreciated from FIG. 1, it may be necessary or desired to enter a start code at a beginning of the sequences 106 and 204, e.g., using the syntax just described. Meanwhile, a location 302 is illustrated that includes a byte sequence that coincidentally has the start code syntax just described, i.e., 0x00 0x00 0x01 0x1B. Such a sequence represents a false or potential start code that happens to be included in the bitstream 102, analogous to the potential marker code 120 of FIG. 1.

In FIG. 3B, then, it may be seen that the marker code 112 (start code 112 in this example) is included as 0x00 0x00 0x01 0x0F, with the offset value 114 of 0x00 0x0F, followed by the sequence 106. Meanwhile, the marker code 116 is included as 0x00 0x00 0x01 0x0D, with the offset value 118 of 0x22 0x31. As shown in FIG. 3B (and appreciated from FIG. 2 and the above discussion), an indicator 202 indicates that the offset value 114 of 0x00 0x0F provides a number of bytes (here, in hexadecimal format indicating a distance of 15 bytes) to the next start code 116, which is shown as 0x00 0x00 0x01 0x0D, with the offset value 118 of 0x22 0x31.

FIG. 3B also illustrates an effect of the false or potential start code 120. That is, as shown, the marker code detection system 124 (e.g., the scanner 142) may detect the potential marker code pattern 120 of 0x00 0x00 0x01 0x1B. Then, the offset extractor 144 may determine that the next two bytes represent a potential offset value 122, shown as 0x00 0x02. To check a validity (or lack thereof) of the potential marker code 120, the code verifier 146 may follow the potential offset value 122 (i.e., may temporarily assume the potential offset value 122 to be valid) the indicated number of bytes (i.e., 2 bytes) to determine a validity code 304, i.e., a portion of the modified bitstream 102a that happens to be pointed to by the potential offset value 122 (as shown by an indicator 306). As is likely, the potential offset value 122 does not point to the next subsequent start code, or any other start code, but rather points to the meaningless (for these purposes) validity code 304 of 0x34. Consequently, the code verifier 146 may determine that the potential start code 120 is not an actual start code, and, in this example, the scanner 142 may continue scanning the modified bitstream 102a to reach the start code 116 (which may then be validated, if necessary, using the included offset value of 118 to check for the presence of a subsequent start code (now shown in FIG. 3B).

In the example of FIGS. 3A and 3B, it may be seen that the potential marker code 120 is illustrated between the marker codes (start codes) 112, 116. This is opposed to FIG. 1, where the potential marker code 120 is illustrated in front of the marker codes 112, 116. In general, though, it will be appreciated that these are merely examples to illustrate the use and operation of the marker code insertion system 110 and the marker code detection system 124, where reference numerals are maintained for clarity and conciseness of description.

Further, it will be appreciated that in examples where the scanner 142 initially recognizes the start code 112 (for subsequent validation thereof by the code verifier 146), the result may be that scanning will continue with the next start code 116 (i.e., the false or potential marker code 120 may not even be scanned, due to the use of the offset value 114 to proceed directly to the start code 116). Nonetheless, in other examples, it may occur that the scanner 142 receives (and begins scanning) the modified bitstream 102a at an early stage of the sequence 106, i.e., after the start code 112. In such cases, the potential marker (start) code 120 may be scanned and determined not to be a valid start code as described above, before the scanner 142 proceeds to validate the start code 116 using the offset value 118 and a subsequent marker/validity code (not shown in FIG. 3B).

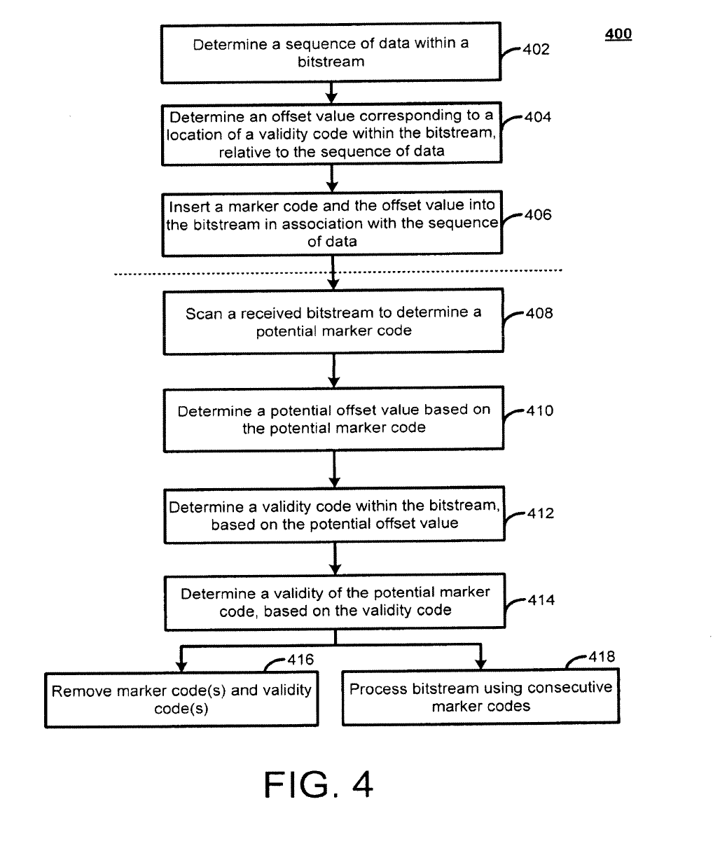

FIG. 4 is a flowchart 400 illustrating example operations of the system 100 of FIG. 1. In FIG. 4, in example implementations, operations 402-406 (above the dashed line) may represent operations performed by the marker code insertion system 110, while operations 408-418 (below the dashed line) may represent operations performed by the marker code detection system 124. As described above, these groups of operations may respectively be performed at the encoder 104 and the decoder 128, or, in other implementations, all of the operations 402-418 may be performed at the decoder 128.

In the example of FIG. 4, a sequence of data may be determined within a bitstream (402). For example, the sequence identifier 136 may be configured to identify the sequence 106 within the bitstream 102. The sequence identifier 136 may identify, for example, a number of such sequences within the bitstream 102, based on information available from the data generator 132 or the data packetizer 134, For example, the data generator 132 may have access to encoding information that specifies that every video sequence should be identified for association with a marker code, or may have access to other rules or information specifying whether and how sequences should be identified for inclusion of corresponding marker codes.

An offset value corresponding to a location of a validity code within the bitstream may be determined, relative to the sequence of data (404). For example, the offset calculator 138 may be configured to receive the sequence information from the sequence identifier 136, and determine a distance in bytes between the sequences. Then, the offset calculator 138 may determine an offset value for each marker code, based on the determined distance. In the above examples, the offset values are determined based on a distance between each offset value and an immediately-subsequent, secondary marker code, so that, as described, the immediately-subsequent marker code may later act as the validity code for checking a validity of a current (potential) marker code.

In other examples, the validity code need not be the immediately-subsequent marker code, and may instead be some later marker code (for example, a marker code of a same type as a marker code being checked, even if one or more different type(s) of marker codes are included in between these two same-type marker codes).

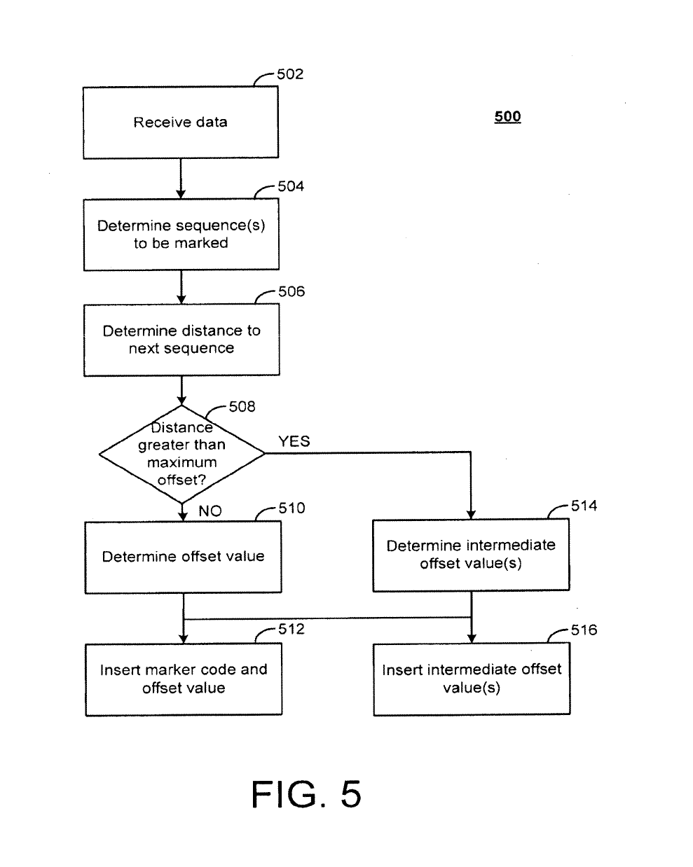

In other examples, the validity code need not be a marker code at all. For example, the intermediate offset value 206 (discussed above and in more detail below, e.g., with respect to FIG. 5) may serve as the validity code for the marker code 112, since a pointing of the offset value 114 to the intermediate offset value 206 may be sufficient to make an initial determination of validity of the marker code 112. Other codes may be inserted within the modified bitstream 102a as the validity code, as well, although such validity codes may or may not provide the function of pointing to a subsequent marker code (and corresponding avoidance of scanning intervening data between marker codes).

A marker code and the offset value may be inserted into the bitstream in association with the sequence of data (406). For examp)e, the code insertion logic 140 may be configured to include the marker code 112 and the offset value 114 into the bitstream 102 in front of the sequence 106, in order to obtain the modified bitstream 102a. In the examples above of FIGS. 1-3B, the offset value 114 is illustrated as being included within and/or appended to an end of the marker code 112 (e.g., may be the last two bytes of a six byte sequence). However, the code insertion logic 140 may insert the marker code 112 in any conventional way, and may include the offset value 114 in any location that may allow use thereof for validating the marker code 112, including, for example, a beginning or middle of the marker code 112, or a location that may be separate from the marker code 112 within the modified bitstream 102a.

A received bitstream may be scanned to determine a potential marker code (408). For example, the scanner 142 may be configured to scan the modified bitstream 102a as the modified bitstream 102a is received, beginning with data 108a. As described, such scanning may begin at an actual beginning of the modified bitstream 102a, or may begin at any time that receipt of the modified bitstream 102a is received by the marker code detection system 124. The scanner 142 may scan the modified bitstream 102a by comparing received data within the modified bitstream 102a against a known, agreed (i.e., agreed with the marker code insertion system 110) marker code format to determine the potential marker code, as described with respect to FIG. 3.

A potential offset value may be determined based on the potential marker code (410). For example, the offset extractor 144 may be configured to determine the offset value 114 and/or the potential offset value 122, based on a knowledge of, or agreement with, the marker code insertion system 110 that offset values have a certain length and are inserted at a defined location within the modified bitstream 102a relative to a corresponding marker code. For example, the offset extractor 144 may have knowledge that offset values inserted by the offset calculator 138 and code insertion logic 140 are designed to have two bytes of data and to be inserted at a beginning, middle, or end of a corresponding marker code. Thus, the offset extractor 144 may automatically extract data having these characteristics from any potential marker code, as described above in FIG. 3B with respect to the potential (and in this example, false) marker code 120 and offset value 122.

A validity code may be determined within the bitstream, based on the offset value (412). For example, the code verifier 146 may be configured to receive the determined, potential offset value from the offset extractor 144, and to

A validity of the marker code may be determined, based on the validity code (414). For example, as described, the code verifier 146 may be configured to add the potential offset value to a current byte location and examine the data at the designated location as the validity code. If the validity code determined in this way matches an expected value or has an expected characteristic, e.g., is itself a start code or an intermediate offset value, then the code verifier 146 may determine that the potential marker code is an actual marker code.

The marker code(s) and validity code(s) may be removed (416), and/or the bitstream may be processed using consecutive marker codes (418). For example, the code locator 148 may be configured to scan the modified bitstream 102a to identify included marker codes and thereby identify corresponding sequences of interest, and, if necessary or desired, may remove the marker code(s) 112, 116, once these marker codes are recognized and processed as such.

FIG. 5 is a flowchart 500 illustrating example insertion operations of the marker code insertion system 110 of FIG. 1. Thus, the flowchart 500 may be considered to provide more detailed examples of the operations 402-406 of FIG. 4, described above.

In the example of FIG. 5, data is received (502), e.g., by the sequence identifier 136, which may be implemented, for example, within the encoder 104, e.g., within the data packetizer 134, as described above. The sequence identifier 138 may further determine which of these sequences are to be marked with a (given type of) marker code (504).

The offset calculator 138 may determine a distance to a subsequent sequence (506), where this distance will ultimately reflect a distance from a determined offset value to a subsequent marker code. That is, the assumption in this example is that the subsequent marker code will be placed somewhere after the determined offset value, and at a beginning of the subsequent sequence.

If the determined distance is not greater than a maximum available offset distance (508), then the offset calculator 138 may calculate the offset value and encode the offset value according to a determined scheme (e.g., as the last byte(s) of a marker code to be inserted). Then, the code insertion logic 140 may encode the (types of) marker code(s) according to a defined scheme (e.g., the four byte scheme above in FIG. 3B in which the fourth byte indicates a type of marker code or start code), and may insert the resulting marker code and offset value into the bitstream 102 to obtain the modified bitstream 102a (512).

lf, however, the determined distance is greater than a maximum available offset distance (508), then the offset calculator 138 may determine one or more intermediate offset values, such as the intermediate offset value 206, that may be used, for example, to bridge a gap between an offset value appended to a marker code and a next-subsequent marker code (e.g., validity code). A number of required intermediate offset values, and a value for each, may be determined recursively by the offset calculator 138, e.g., by repeatedly checking whether a maximum value of an additional byte distance added by an n^{th} intermediate offset value is sufficient to reach the next-subsequent marker code. If not, then the n^{th} intermediate offset value may be set to a maximum value/distance and the next intermediate offset value may be placed at that distance. This process may be repeated to establish a chain of intermediate offset values, each pointing to the next, until a final intermediate offset value is reached that has sufficient capacity to reach the next-subsequent marker code. Once the necessary number of intermediate offset values are properly encoded, e.g., as just described, then the marker codes, offset values, and intermediate offset values may be inserted (512, 516) into the bitstream 102 to obtain the modified bitstream 102a. The process 500 may be repeated recursively for pairs of marker codes (corresponding to pairs of sequences to be marked), or the bitstream 102 may be analyzed as a whole, with marker codes/offset values/intermediate offset values inserted after such analysis.

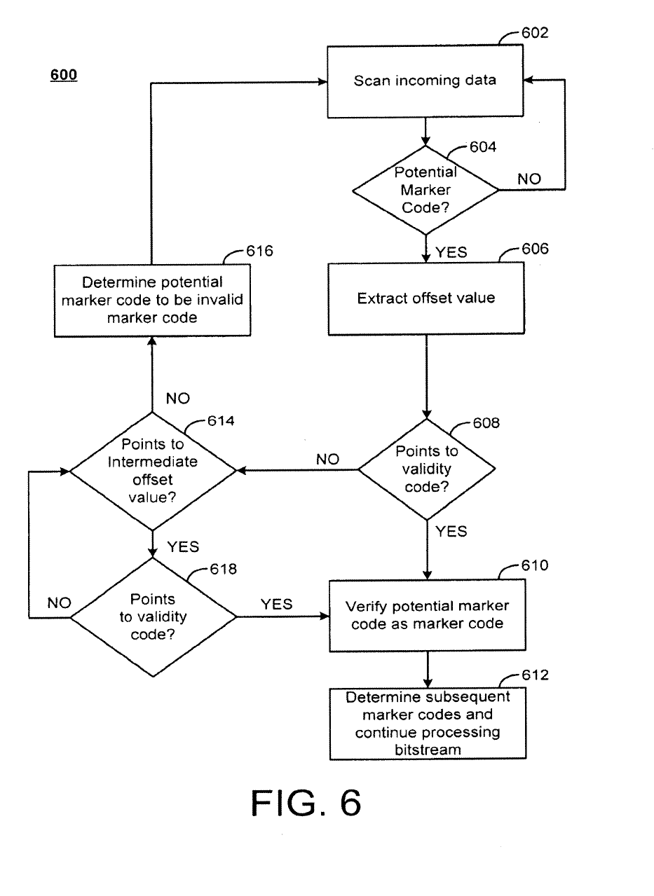

FIG. 6 is a flowchart 600 illustrating example detection operations of the marker code detection system 124 of FIG. 1. Thus, the flowchart 600 may be considered to provide more detailed examples of the operations 408-418 of FIG. 4, described above.

In the example of FIG. 6, the scanner 142 may scan incoming data (602), e.g., within a bitstream 102 that may be received from an active network connection or from a file storing the data of the modified bitstream 102a. The scanning may occur within an order of data within the modified bitstream 102a, e.g., starting with the data 108a in FIG. 1 and proceeding through subsequent portions of the modified bitstream 102a until the potential marker code 120 is reached (604) (otherwise scanning continues).

Once recognized by the scanner 142, the offset extractor 144 may be used to extract the potential offset value 122, e.g., by analyzing the last two bytes of a six-byte sequence that includes the known marker code pattern, as described with respect to FIG. 3B. If the extracted, potential offset value does not point to a validity code (608), such as a subsequent marker code having the known marker code pattern, then the code verifier 146 may determine whether the extracted, potential offset value 122 points to an intermediate offset value (610). If not, then the potential marker code 120 is determined not to be a valid marker code (612), and scanning continues (602).

Consequently, the scanner 142 may scan the data 108b, not determining any potential marker codes, until the marker code 112 is reached (604). Again the offset extractor 144 may extract the offset value 114 (606), and if the offset value 114 points to a validity code (608), such as the when the offset value points to the validity/marker code 116 as shown by the indicator 202, then the code verifier 146 may verify the (potential) marker code 112 as a valid marker code (614). Otherwise, if the offset value 114 does not point to a validity code (608), but instead points to the intermediate offset value 206 (610) as shown in FIG. 2 by the indicator 208, then the code verifier 146 may determine whether the intermediate offset value 206 points to a validity code (618). If not, then the process would repeat with a determination of whether the intermediate offset value 206 itself points to a subsequent intermediate offset value (610), until a determination is made that a final intermediate offset value points to the validity code (618), and the code verifier 146 may verify the potential marker code as a valid marker code (614).

Once validated, the code locator 148 may easily progress through the modified bitstream 102a simply by following an offset value of each marker code to a secondary/subsequent marker code, without having to scan intervening data for potential marker codes (616). Consequently, in this example, processing (e.g., synchronizing) of the modified bitstream 102a may be eased as compared to alternative techniques for prevention of false marker codes (which may require a complete scanning of all of the data of the modified bitstream 102a to ensure that no false marker codes are included (and/or have been accounted for).

Many other examples and features may be included that are not necessarily discussed here. For example, if additional robustness is needed, a length of the marker codes may be increased (e.g., from four bytes with a two byte offset value to six bytes with a two byte offset value). It will be appreciated from the above that such relatively longer marker codes may be used to reduce the probability that an actual or false marker code may appear at the location pointed to by the offset value of the (longer) marker code.

Thus, while certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

1-20. (canceled)

21. A device, comprising:
a scanner configured to scan a bitstream to identify a first portion of the bitstream that potentially corresponds to a first marker code;
an extractor configured to extract a second portion of the bitstream that is associated with the first portion of the bitstream, the second portion of the bitstream to be used as an offset; and
a code verifier configured to:
identify a third portion of the bitstream that potentially corresponds to a second marker code based at least on the first portion of the bitstream and the second portion of the bitstream, and
determine whether the first portion of the bitstream corresponds to the first marker code based at least on a determination of whether the third portion of the bitstream corresponds to the second marker code.

22. The device of claim 21, further comprising:
a receiver configured to receive the bitstream; and
a decoder configured to begin decoding the received bitstream at a location associated with the first portion of the bitstream when the first portion of the bitstream corresponds to the first marker code.

23. The device of claim 22, wherein the decoder is configured to:
access a requested location in the bitstream by skipping from the first portion of the bitstream to the third portion of the bitstream when the first portion of the bitstream is determined to correspond to the first marker code.

24. The device of claim 21, wherein the second portion of the bitstream comprises an offset value that points to the third portion of the bitstream when the first portion of the bitstream corresponds to the first marker code, otherwise the second portion of the bitstream is exclusive of the offset value that points to the third portion of the bitstream.

25. The device of claim 21, wherein the first portion of the bitstream comprises a marker code pattern and the code verifier is configured to:
determine that the first portion of the bitstream corresponds to the first marker code when the second portion of the bitstream comprises the marker code pattern; and
determine that the first portion of the bitstream does not correspond to the first marker code when the second portion of the bitstream is exclusive of the marker code pattern.

26. The device of claim 21, wherein the code verifier is configured to:
identify a fourth portion of the bitstream by using the second portion of the bitstream as the offset from the first portion of the bitstream; and
identify the third portion of the bitstream by using the fourth portion of the bitstream as another offset from the fourth portion of the bitstream.

27. The device of claim 21, wherein the code verifier is configured to:
remove the first portion of the bitstream from the bitstream when the first portion of the bitstream is determined to correspond to the first marker code.

28. The device of claim 21, wherein the code verifier is configured to:
scan the bitstream to identify a fourth portion of the bitstream that potentially corresponds to the first marker code when the first portion of the bitstream is determined not to correspond to the first marker code;
extract a fifth portion of the bitstream that is associated with the fourth portion of the bitstream, the fifth portion of the bitstream to be used as another offset;
identify a sixth portion of the bitstream that potentially corresponds to the second marker code based at least on the fourth portion of the bitstream and the fifth portion of the bitstream; and
determine whether the fourth portion of the bitstream corresponds to the first marker code based at least on another determination of whether the sixth portion of the bitstream corresponds to the second marker code.

29. The device of claim 21, wherein the first portion of the bitstream comprises the second portion of the bitstream.

30. A computer program product comprising instructions stored in a tangible computer-readable storage medium, the instructions comprising:
instructions for scanning a bitstream to identify a potential marker code within the bitstream;
instructions for identifying a potential offset value that is associated with the potential marker code; and
instructions for determining that the potential marker code is a marker code when another marker code in the bitstream is identifiable based at least on the potential marker code and the potential offset value.

31. The computer program product of claim 30, wherein the instructions further comprise:
instructions for receiving the bitstream; and
instructions for beginning to decode the bitstream at a bit associated with the potential marker code when the potential marker code is determined to be the marker code.

32. The computer program product of claim 30, wherein the potential marker code comprises a marker code pattern.

33. The computer program product of claim 32, wherein the instructions for determining that the potential marker code is the marker code when the another marker code in the bitstream is identifiable based at least on the potential marker code and the potential offset value comprises:
instructions for determining a location in the bitstream from the potential marker code and the potential offset value;
instructions for determining that the potential marker code is the marker code when the bitstream comprises the marker code pattern starting at the determined location in the bitstream; and
instructions for determining that the potential marker code is not the marker code when the bitstream does not comprise the marker code pattern starting at the determined location in the bitstream.

34. The computer program product of claim 32, wherein the instructions for determining that the potential marker code is the marker code when the another marker code in the bitstream is identifiable based at least on the potential marker code and the potential offset value comprises:
instructions for determining a location in the bitstream that comprises another potential offset value based at least on the potential marker code and the potential offset value; and
instructions for determining that the potential marker code is the marker code when the bitstream comprises the marker code pattern starting at another location in the bitstream that is determinable from the location in the bitstream and the another potential offset value.

35. The computer program product of claim 30, wherein the potential marker code comprises the potential offset value, the potential offset value comprises an offset value that points to the another marker code when the potential marker code comprises the marker code, and the potential offset value is exclusive of the offset value that points to the another marker code when the potential marker code does not comprise the marker code.

36. The computer program product of claim 30, wherein the instructions further comprise:
instructions for removing the potential marker code from the bitstream when the potential marker code is the marker code.

37. A method for marker code insertion, comprising:
identifying a first location in a bitstream for inserting a first marker code and a second location in the bitstream for inserting a second marker code;
determining an offset value that is indicative of the second location in the bitstream relative to the first location in the bitstream; and
inserting the first marker code and the offset value at the first location in the bitstream and the second marker code at the second location in the bitstream.

38. The method of claim 37, wherein identifying the first location in the bitstream for inserting the first marker code and the second location in the bitstream for inserting the second marker code comprises:
identifying a first random access point at the first location in the bitstream for inserting the first marker code; and
identifying a second random access point at the second location in the bitstream for inserting the second marker code.

39. The method of claim 37, further comprising:
transmitting the bitstream with the inserted first and second marker codes, and the inserted offset value.

40. The method of claim 39, wherein the first and second marker codes each comprise a marker code pattern, and the method further comprising:
receiving the transmitted bitstream;
scanning the bitstream for the first marker code using at least the marker code pattern;
extracting the offset value from the bitstream, the offset value being indicative of the second location in the bitstream;
verifying that the second marker code that comprises the marker code pattern begins at the second location in the bitstream; and
beginning to decode the bitstream at a first bit subsequent to the first marker code when the second marker code is verified as comprising the marker code pattern.
